(19) United States
(12) Patent Application Publication
(10) Pub. No.: US 2025/0030658 A1
(43) Pub. Date: Jan. 23, 2025

(54) DOMAIN NAME QUERY METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Yong YANG, Shenzhen (CN)

(21) Appl. No.: 18/908,676

(22) Filed: Oct. 7, 2024

Related U.S. Application Data
(63) Continuation of application No. PCT/CN2023/123894, filed on Oct. 11, 2023.

(30) Foreign Application Priority Data
Nov. 23, 2022 (CN) 202211478295.4

(51) Int. Cl. H04L 61/4511; H04L 61/5007

(52) U.S. Cl. CPC H04L 61/4511; H04L 61/5007

(57) ABSTRACT

This application discloses a domain name query method and apparatus, a device, and a storage medium, and relates to the field of mobile communications. The method includes receiving a domain name system (DNS) query request from a terminal device, the DNS query request comprising a domain name; determining, based on cached data of a user plane function (UPF), an Internet protocol (IP) address corresponding to the domain name; and transmitting a DNS response to the terminal device, the DNS response comprising the IP address corresponding to the domain name.

### RELATED APPLICATIONS

This application is a continuation of PCT Application No. PCT/CN2023/123894, filed on Oct. 11, 2023, which in turn claims priority to Chinese Patent Application No. 2022114782954, filed with the China National Intellectual Property Administration on Nov. 23, 2022, and entitled “DOMAIN NAME QUERY METHOD AND APPARATUS, DEVICE, AND STORAGE MEDIUM”, which are incorporated herein by reference in their entirety.

### FIELD OF THE TECHNOLOGY

Embodiments of this application relate to the field of mobile communications, and in particular, to a domain name query technology.

### BACKGROUND OF THE DISCLOSURE

Domain name resolution is an Internet service that supports interconversion of domain names and Internet protocol (IP) addresses. In related art, domain name resolution is used to transmit a domain name query request from a terminal device to a domain name resolution server of a public network through network devices, query a mapping relationship between a domain name and an IP address by the domain name resolution server of the public network, and return a query result.

However, a network communication link between the domain name resolution server of the public network and the terminal device is excessively long, and the domain name resolution server of the public network generally needs to process a large number of domain name query requests concurrently, resulting in an excessively heavy processing load. Consequently, domain name query in related art is generally slow, and this further negatively affects subsequent Internet service access of the terminal device.

In view of this, it is desirable to speed up domain name query in such use scenarios.

### SUMMARY

This application provides a domain name query method and apparatus, a device, and a storage medium, to speed up domain name query. The technical solutions are as follows.

According to an aspect of this application, a domain name query method is provided. The method is performed by a computer device and includes receiving a domain name system (DNS) query request from a terminal device, the DNS query request comprising a domain name; determining, based on cached data of a user plane function (UPF), an Internet protocol (IP) address corresponding to the domain name; and transmitting a DNS response to the terminal device, the DNS response comprising the IP address corresponding to the domain name.

According to another aspect of this application, a computer device is provided. The computer device includes: a processor and a memory. The memory has a computer program stored therein, and the computer program is loaded and executed by the processor. The computer device implements the foregoing domain name query method.

According to another aspect of this application, a non-transitory computer-readable storage medium is provided. The computer-readable storage medium has a computer program stored thereon, and the computer program is loaded and executed by a processor. The computer-readable storage medium implements the foregoing domain name query method.

The technical solutions provided in embodiments of this application have at least the following beneficial effects:

Domain name query is performed by a computer device configured to implement a user plane function (UPF). Compared with a method in related art where a DNS query request is transmitted to a DNS server of a public network through a long network communication link, in embodiments consistent with this application, before a DNS query request is transmitted to a DNS server of a public network, domain name query corresponding to the DNS query request can be completed based on cached data of a UPF by a computer device configured to implement the UPF. As a result, a network communication link needed is short, thereby speeding up the domain name query process. In addition, because the DNS query request does not need to reach the DNS server of the public network, the number of DNS query requests that need to be processed by the DNS server can be reduced, so that a processing load of the DNS server of the public network is reduced. Furthermore, the method provided in embodiments of this application can be implemented by the existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented.

### BRIEF DESCRIPTION OF THE DRAWINGS

FIG. 1 is a schematic diagram of a domain name query process in related art.

FIG. 2 is a schematic diagram of a domain name query process in related art.

FIG. 3 is a block diagram of a structure of a communication system according to some embodiments of this application.

FIG. 4 is a schematic diagram of a structure of a communication system according to some embodiments of this application.

FIG. 5 is a schematic flowchart of a domain name query method according to some embodiments of this application.

FIG. 6 is a schematic flowchart of a domain name query method according to some embodiments of this application.

FIG. 7 is a schematic flowchart of a domain name query method according to some embodiments of this application.

FIG. 8 is a schematic diagram of a domain name query method according to some embodiments of this application.

FIG. 9 is a schematic diagram of a domain name query method according to some embodiments of this application.

FIG. 10 is a schematic diagram of a domain name query method according to some embodiments of this application.

FIG. 11 is a schematic diagram of a domain name query method according to some embodiments of this application.

FIG. 12 is a schematic flowchart of a domain name query method according to some embodiments of this application.

FIG. 13 is a block diagram of a structure of a domain name query apparatus according to some embodiments of this application.

FIG. 14 is a schematic diagram of a structure of a communication device according to some embodiments of this application.

### DESCRIPTION OF EMBODIMENTS

First, a brief introduction to related art in embodiments of this application is provided below.

### Domain Name System (DNS):

The DNS is used for implementing mutual mapping between a domain name and an Internet protocol (IP) address. Both the domain name and the IP address can be used to label a computing device in a network, and the domain name is equivalent to an alias of the IP address. The domain name includes letters, numbers, characters in a variable length (for example, www.xxxx.com), and the IP address includes four sets of numerals in a strict sequence (for example, 202.96.133.134).

### Domain Name Resolution:

For a user, it is more difficult to remember an IP address than a domain name, and compared with a method of entering an IP address in an input field, entering a domain name in the input field for network communication is an easier operation.

However, a network communication protocol used in the network communication is implemented based on IP addresses, and a computer recognizes an IP address rather than a domain name during the network communication. In this case, when a user enters the domain name in an input field, a service that supports conversion between domain names and IP addresses is required for the network communication of the computer. The service is referred to as the domain name resolution, and a server that provides the service is referred to as a domain name resolution server or a DNS server.

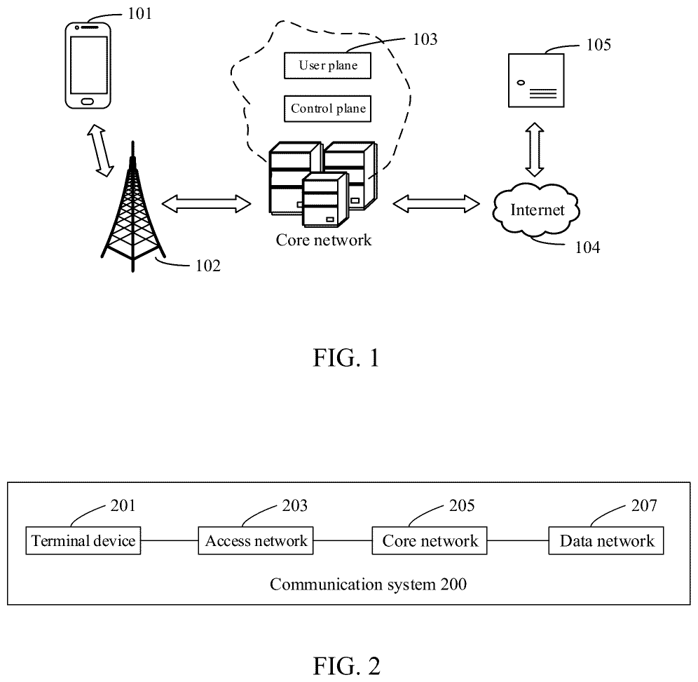

In related art, DNS domain name resolution is generally to transmit, by a terminal device, a request for querying a domain name to a domain name resolution server of a public network (or referred to as a wide area network), query a mapping relationship between a domain name and an IP address by the domain name resolution server of the public network, and return a query result. This process is also considered as a domain name query process. The domain name resolution server of the public network may also be considered as a public domain name resolution server, and an IP address is typically 8.8.8.8 or 114.114.114.114. Specifically, a DNS domain name resolution process commonly used in the related art is shown in FIG. 1. A terminal device 101 transmits a DNS request to a base station 102. The DNS request includes a domain name that the terminal device 101 requests to query. The DNS request reaches the Internet 104 through a core network user plane device (UPF) 103, and then is transmitted to a DNS server 105 of a public network through routers and switches in the Internet 104. After receiving the DNS request, the DNS server 105 of the public network searches an IP address corresponding to the domain name that the terminal device 101 requests to query, then constructs a corresponding DNS response based on the identified IP address, and transmits the DNS response. The DNS response reaches the core network UPF 103 through a plurality of routers and switches. The core network UPF 103 finally returns the DNS response to the terminal device 101 through the base station 102. The terminal device 101 may perform subsequent Internet service access based on the received DNS response.

However, the DNS server 105 of the public network is often physically far from the terminal device 101, and a network communication link between the DNS server 105 and the terminal device 101 is long. In addition, the DNS server of the public network generally needs to concurrently process a large number of DNS requests, and the processing load of domain name resolution is heavy. In this case, the foregoing method leads to excessively long processing time of domain name resolution, that is, excessively long time for the domain name query, and even leads to failure of domain name resolution in severe cases, resulting in affecting time and efficiency of service access of the terminal device, and even resulting in failure of the terminal device to access an Internet service.

To resolve the foregoing problems, this application provides a domain name query method, to speed up domain name query by using a computer device implementing a UPF, and the method has the advantages of low costs, high efficiency, and good compatibility. The domain name query method and an apparatus corresponding to the domain name query method, a device, and a storage medium are described below by using a number of embodiments.

FIG. 2 is a schematic diagram of an architecture of a communication system 200 according to some embodiments of this application. As shown in FIG. 2, the communication system 200 may include at least one of the following: a terminal device 201, an access network 203, a core network (CN) 205, or a data network (DN) 207. The terminal device 201, the access network 203, and the core network 205 may be logically divided into two parts, namely, a user plane and a control plane. The control plane is responsible for management of a mobile network, and the user plane is responsible for transmission of service data.

The terminal device 201 is an entry for interaction between a mobile subscriber and a network, and can provide basic computing capabilities and storage capabilities, display a service window to a user, and receive operation input by the user. The terminal device 201 establishes a signal connection and a data connection with the access network 203 using a specific air interface technology, to transmit a control signal and service data to the mobile network. Terminal device 201 may be deployed on land, on water, in the air, and the like, and include but is not limited to a handheld device, a wearable device, a vehicle-mounted device, an Internet of Things device, and the like. For example, Terminal device 201 may be a mobile phone, a tablet computer, an e-book reader, a laptop portable computer, a desktop computer, a television, a game console, a mobile Internet device (MID), an augmented reality (AR) terminal, a virtual reality (VR) terminal and a mixed reality (MR) terminal, a wearable device, a handle, an electronic tag, a controller, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, a wireless terminal in a remote medical surgery, a cellular phone, a cordless phone, a session initiation protocol (SIP) phone, a wireless local loop (WLL) station, a personal digital assistant (PDA), a set top box (STB), a customer premise equipment (CPE), and the like.

The access network 203 is configured to implement an access-related function, may provide a network access function for authorized users in a cell coverage area, and may use transmission tunnels with different qualities to transmit user data based on a level of a user, a service requirement, and the like. The access network 203 can manage and make reasonable use of its own resources, provide an access service for the terminal device 201 as needed, and forward a control signal and user data between the terminal device 201 and the core network 205. The access network 203 may include an access network device. The access network device may be a device providing an access service to the terminal device 201, and may include a radio access network (RAN) device and an AN device. The RAN device is mainly a wireless network device in a 3GPP network. The AN device may be an access network device not defined by 3GPP. In systems using different radio access technologies, a device having a base station function may have different names. For example, in a 5th generation mobile communication technology (5G) system, the device may be referred to as a RAN or a next generation node base station (gNB), and in a long term evolution (LTE) system, the device is referred to as an evolved NodeB (eNB or eNodeB).

The core network 205 is responsible for maintaining subscription data of the mobile network, managing a network element of the mobile network, and providing functions such as session management, mobility management, policy management, security authentication, and the like for the terminal device 201. For example, when the terminal device 201 is attached, network access authentication is provided for the terminal device 201; when the terminal device 201 has a service request, network resources are allocated to the terminal device 201; while the terminal device 201 moves, the network resources are updated for the terminal device 201; when the terminal device 201 is idle, a fast recovery mechanism is provided for the terminal device 201; when the terminal device 201 is detached, the network resources are released for the terminal device 201; and when the terminal device 201 has service data, a data routing function is provided for the terminal device 201, for example, uplink data is forwarded to the data network 207, or downlink data transmitted to the terminal device 201 is received from the data network 207 and forwarded to the access network 203, so as to transmit the downlink data to the terminal device 201. The core network 205 is deployed in a private network or in a public network.

The data network 207 is configured to provide a business service to a user. The data network 207 may be a private network, such as a local area network, an external network not controlled by an operator, such as the Internet, or a proprietary network co-deployed by operators, such as an IP multimedia network subsystem (IMS). The terminal device 201 may access the data network 207 through an established protocol data unit (PDU) session.

In some embodiments, at least one of the access network 203, the core network 205, or the data network 207 may be considered as a network device.

For example, there are two communication scenarios in the communication system 200: an uplink communication scenario and a downlink communication scenario. Uplink communication means that signals are transmitted in a direction of the terminal device 201, the access network 203, the core network 205, and the data network 207, and downlink communication means that signals are transmitted in a direction of the data network 207, the core network 205, the access network 203, and the terminal device 201.

In some embodiments of this application, the “5G” may also be referred to as a “5G new radio (NR)” or “NR”, and the “terminal device” may also be referred to as a user equipment (UE), an access terminal, a subscriber unit, a subscriber station, a mobile station, a mobile console, a remote station, a remote terminal, a mobile device, a user terminal, a terminal, a wireless communication device, a user agent, or a user apparatus.

The technical solutions described in some embodiments of this application may be applied to a 5G system and an LTE system, evolution systems of a 5G system and an LTE system, or a beyond 5th generation (B5G) system, a 6G system, and a subsequent evolution system. The 5G system may include at least one of a non-standalone (NSA) networking or a standalone (SA) networking.

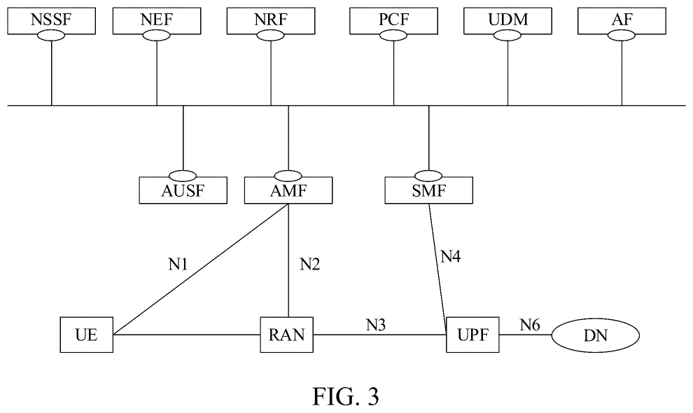

FIG. 3 is a detailed architecture determined based on FIG. 2. A user plane of a core network includes a UPF, and a control plane of the core network includes an authentication server functions (AUSF), an access and mobility management function (AMF), a session management function (SMF), a network slice selection function (NSSF), a network exposure function (NEF), a network repository function (NRF), unified data management (UDM), a policy control function (PCF), an application function (AF). Functions of these functional entities are as follows.

The AMF is mainly responsible for mobility management in a mobile network, for example, user location update, a user registration network, and user handover. The SMF is mainly responsible for session management in the mobile networks, for example, session establishment, modification, and release. The PCF mainly supports providing a unified policy framework to control network behavior, providing policy rules to a control layer network function, and is responsible for obtaining user subscription information related to policy decision. The AUSF is configured to perform security authentication of a terminal. The NEF is mainly configured to support opening of capabilities and events. The NRF is configured to provide a storage function and a selection function of network function entity information for another network element. The UDM is configured to store user data, for example, subscription data and authentication or authorization data. The AF interacts with the core network to provide an application layer service, for example, providing application layer data routing, provide an access network capability exposure function, interact with a policy framework to provide policy control, and interact with an IMS.

In this embodiment, the UPF is not only responsible for forwarding and receiving user data, but also has a related function of domain name query. In other words, the UPF may not only receive user data from a data network and transmit the user data to a terminal device through the access network, but also receive user data from a terminal device through an access network and forward the user data to a data network. In addition, the UPF may implement functions related to domain name resolution, for example, domain name caching and domain name query.

In the architecture shown in FIG. 3, an N1 interface is a reference point between UE and the AMF; an N2 interface is a reference point between a RAN and the AMF and is configured to transmit a non-access stratum (NAS) message and the like; an N3 interface is a reference point between the RAN and the UPF and is configured to transmit user plane data and the like; an N4 interface is a reference point between the SMF and the UPF and is configured to transmit information such as N3 connection tunnel identifier information, data caching indication information, and a downlink data notification message; and an N6 interface is a reference point between the UPF and the DN and is configured to transmit user plane data and the like. An NG interface is an interface between the RAN and the CN.

Names of the interfaces between the network elements in FIG. 2 and FIG. 3 are merely examples, and the names of the interfaces in specific implementations may be other names, which are not specifically limited by the embodiments of this application. Names of the network elements (for example, the SMF, the AF, and the UPF) included in FIG. 2 and FIG. 3 are also merely examples, and constitute no limitation on functions of the network elements. In a network in related art and or in a future network, the foregoing network elements may also have other names, which are not specifically limited in embodiments of this application. For example, in a 6G network, some or all of the foregoing network elements may use the terminology in 5G, other names, and the like, which are described in detail herein and are not described below again. In addition, names of transmitted messages (or signaling) between the foregoing network elements are also merely examples, and constitute no limitation on functions of the messages.

Information (including but not limited to user equipment information, user personal information, and the like), data (including but not limited to data for analysis, stored data, displayed data, and the like), and signals in this application are all authorized by users or fully authorized by all parties, and collection, use, and processing of related data need to comply with relevant laws, regulations, and standards of relevant countries and regions. For example, information in this application is obtained under full authorization, and a terminal device and a server only cache the information during running of a program and related data of the information is not solidified for storing and secondarily used.

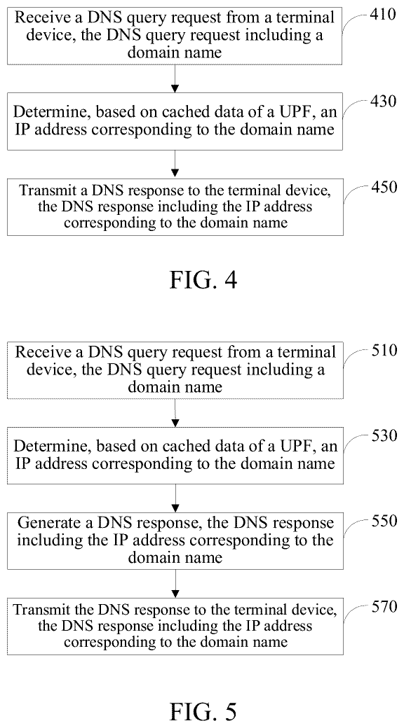

FIG. 4 is a schematic flowchart of a domain name query method according to some embodiments of this application. In this embodiment, an example in which the method is performed by a computer device configured to implement the UPF shown in FIG. 3 is used for description. The method includes at least some of the following operations:

Operation 410: Receive a DNS query request from a terminal device, the DNS query request including a to-be-queried domain name.

The DNS query request is from the terminal device.

The terminal device transmits the DNS query request carrying the to-be-queried domain name to a DNS server, and the DNS server is located in a data network. The DNS query request needs to pass through a network device. The network device is at least one of an access network device or a core network device.

Operation 430: Determine, based on cached data of the UPF, an IP address corresponding to the to-be-queried domain name.

The cached data of the UPF includes some or all of domain names and data related to IP address corresponding to the domain names.

For example, the cached data of the UPF includes DNS cached data, and the DNS cached data includes a mapping relationship between the domain name and the IP address. The UPF queries the IP address corresponding to the to-be-queried domain name in the DNS cached data.

Operation 450: Transmit a DNS response to the terminal device, the DNS response including the IP address corresponding to the to-be-queried domain name.

The DNS response is a response transmitted to the terminal device for the DNS query request.

The UPF transmits the DNS response carrying the IP address corresponding to the to-be-queried domain name to the terminal device. For example, the UPF transmits the DNS response carrying the IP address corresponding to the to-be-queried domain name to the access network device, and the access network device transmits the DNS response to the terminal device.

In conclusion, according to the method provided in this application, domain name query is performed by a computer device configured to implement a UPF. Compared with a method in related art where a DNS query request is transmitted to a DNS server of a public network through a long network communication link, in the method provided in this application, before a DNS query request is transmitted to a DNS server of a public network, domain name query corresponding to the DNS query request can be completed based on cached data of a UPF by a computer device configured to implement the UPF, so that a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced. Furthermore, the method provided in this embodiment can be implemented by the existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented.

FIG. 5 is a schematic flowchart of a domain name query method according to some embodiments of this application. In this embodiment, an example in which the method is performed by a computer device configured to implement the UPF shown in FIG. 3 is used for description. The method includes at least some of the following operations:

Operation 510: Receive a DNS query request from a terminal device, the DNS query request including a to-be-queried domain name.

The DNS query request is from the terminal device.

The terminal device transmits the DNS query request carrying the to-be-queried domain name to a DNS server, and the DNS server is located in a data network. The DNS query request passes through a network device. The network device is at least one of an access network device or a core network device.

In some embodiments, the DNS query request includes at least one of the following:
a user datagram protocol (UDP) based DNS query request;
a transmission control protocol (TCP) based DNS query request; or
a hypertext transfer protocol (HTTP) based DNS query request.

In other words, the DNS query request is at least one of a UDP DNS query request, a TCP DNS query request, or an HTTP DNS query request. In other words, the method provided in this embodiment supports processing various DNS query requests, may be applied to various scenarios, and has high compatibility in various application scenarios.

Operation 530: Determine, based on cached data of the UPF, an IP address corresponding to the to-be-queried domain name.

The cached data of the UPF includes data related to a domain name and an IP address corresponding to the domain name.

In some embodiments, the cached data of the UPF includes DNS cached data, and the DNS cached data is data related to a mapping relationship between the domain name and the IP address. The UPF queries the IP address corresponding to the to-be-queried domain name in the DNS cached data. The cached data of the UPF or the DNS cached data of the UPF is from the DNS server, and the DNS server is located in the data network.

In some embodiments, the cached data of the UPF includes at least one of the following:
hot update cached data;
timing cached data;
default cached data;
static cached data; or
dynamic cached data.

Hot update is an update mode of updating in real time without restarting or turning off the device, and the hot update cached data is data cached to the UPF in the hot update mode. The timing cached data is data cached to the UPF within a specified time period, data cached to the UPF in a periodic mode, or data cached to the UPF in a semi-periodic mode. The default cached data is data cached to the UPF in a pre-configured mode or initial cached data in the UPF. The static cached data is data cached to the UPF in a static caching mode. The dynamic cached data is data cached to the UPF in a dynamic caching mode.

In some embodiments, when the UPF receives a hot update caching request or hot update cached information from the DNS server or satisfies a hot update caching condition, the UPF performs hot update caching during operation. Based on the hot update caching request, the hot update cached information, or the hot update caching condition, the UPF updates the data related to the domain name and the IP address corresponding to the domain name in the cached data of the UPF in real time. Data obtained through the real-time update is the hot update cached data, or data obtained through the real-time update and different from the data before the real-time update is the hot update cached data.

For example, when running time of the UPF reaches a first threshold, the UPF clears the cached data of the UPF or the DNS cached data of the UPF, receives a DNS response of the DNS server based on a DNS query request of the terminal device, and caches data related to the domain name and the IP address corresponding to the domain name in the DNS response to the cached data of the UPF or the DNS cached data of the UPF, so as to implement hot update caching. The first threshold is pre-defined, or pre-configured, or autonomously determined by the UPF, or indicated by the DNS server. The update mode can be implemented without turning off or restarting the UPF, an update process has a small impact on the terminal device, and real-time updating of the cached data of the UPF can be implemented while a domain name query requirement of the terminal device is satisfied. In addition, the update mode is beneficial to maintaining good synchronization between the cached data of the UPF and a change of a DNS service in the data network, so that the DNS cached data of the UPF has good timeliness.

In some embodiments, when the UPF receives a timing caching request from the DNS server, or the UPF receives timing cached information from the DNS server, or the UPF receives timer information, or the UPF satisfies a timing caching condition, the UPF performs timing caching based on the timing caching request, the timing cached information, the timer information, or specified time in the timing caching condition. The UPF updates, based on the timing caching request, the timing cached information, the timer information, or the timing caching condition, the data related to the domain name and the IP address corresponding to the domain name in the cached data of the UPF. Data obtained through the update is the timing cached data, or data obtained through the update and different from the data before the update is the timing cached data. A timer is pre-defined, or pre-configured, or autonomously determined by the UPF, or indicated by the DNS server. The timing caching condition is pre-defined, or pre-configured, or autonomously determined by the UPF, or indicated by the DNS server.

For example, when time for updating the cached data of the UPF last time reaches a second threshold, the UPF transmits a data update request to the DNS server, receives a data update response of the DNS server, and caches data related to the domain name and the IP address corresponding to the domain name in the data update response to the cached data of the UPF or the DNS cached data of the UPF, so as to implement timing caching. The second threshold is pre-defined, or pre-configured, or autonomously determined by the UPF, or indicated by the DNS server. The update mode may be triggered by the DNS server, and the implementation is more flexible. Alternatively, the update mode may be autonomously triggered by the UPF based on time, so that a waste of signaling resources can be reduced. In addition, the update mode is beneficial to maintaining good synchronization between the cached data of the UPF and a change of a DNS service in the data network, so that the DNS cached data of the UPF has good timeliness.

In some embodiments, when in a startup phase, an initialization phase, a configuration phase, or a pre-configuration phase, the UPF receives an initial caching request, initial cached information, a configuration caching request, configuration cached information, a pre-configuration caching request, or pre-configuration cached information or the UPF satisfies a default caching condition, the UPF performs default caching. The UPF updates, based on the initial caching request, the initial cached information, the configuration caching request, the configuration cached information, the pre-configuration caching request, the pre-configuration cached information, or the default caching condition, the data related to the domain name and the IP address corresponding to the domain name in the cached data of the UPF. Data obtained through the update is the default cached data, or data obtained through the update and different from the data before the update is the default cached data.

For example, in the startup phase, the UPF initializes the cached data of the UPF, transmits a data update request to the DNS server, receives a data update response of the DNS server, and caches data related to the domain name and the IP address corresponding to the domain name in the data update response to the cached data of the UPF or the DNS cached data of the UPF, so as to implement default caching. According to the update mode, a domain name query requirement of some of terminal devices can be satisfied when the UPF starts to provide a domain name query service, so that efficiency of processing a domain name query request by the UPF can be improved.

In some embodiments, when static caching is required, for example, when the UPF receives a static caching request or static cached information or satisfies a static caching condition, the UPF performs the static caching. The UPF updates, based on the static caching request, the static cached information, or the static caching condition, the data related to the domain name and the IP address corresponding to the domain name in the cached data of the UPF. Data obtained through the update is the static cached data, or data obtained through the update and different from the data before the update is the static cached data. The update mode is beneficial to maintaining good synchronization between the cached data of the UPF and a change of a DNS service in the data network, so that the DNS cached data of the UPF has good timeliness.

In some embodiments, when dynamic caching is required, for example, when the UPF receives a dynamic caching request or dynamic cached information or satisfies a dynamic caching condition, the UPF performs the dynamic caching. The UPF updates, based on the dynamic caching request, the dynamic cached information, or the dynamic caching condition, the data related to the domain name and the IP address corresponding to the domain name in the cached data of the UPF. Data obtained through the update is the dynamic cached data, or data obtained through the update and different from the data before the update is the dynamic cached data. The update mode is beneficial to maintaining good synchronization between the cached data of the UPF and a change of a DNS service in the data network, so that the DNS cached data of the UPF has good timeliness.

Operation 550: Generate a DNS response, the DNS response including the IP address corresponding to the to-be-queried domain name.

In a case that the cached data of the UPF includes the IP address corresponding to the to-be-queried domain name, the UPF generates the DNS response based on the identified IP address corresponding to the to-be-queried domain name.

The UPF generates the DNS response based on a mapping relationship between the identified IP address and the to-be-queried domain name.

Operation 570: Transmit the DNS response to the terminal device, the DNS response including the IP address corresponding to the to-be-queried domain name.

The DNS response is transmitted to the terminal device.

The UPF transmits the DNS response carrying the IP address corresponding to the to-be-queried domain name to the terminal device. For example, the UPF transmits the DNS response carrying the IP address corresponding to the to-be-queried domain name to the access network device, and the access network device transmits the DNS response to the terminal device.

In conclusion, according to the method provided in this application, in a case that cached data in a UPF includes an IP address corresponding to a to-be-queried domain name, domain name query corresponding to a DNS query request is completed based on the cached data of the UPF by a computer device configured to implement the UPF, so that compared with transmitting the DNS query request to a DNS server in a public network, a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced.

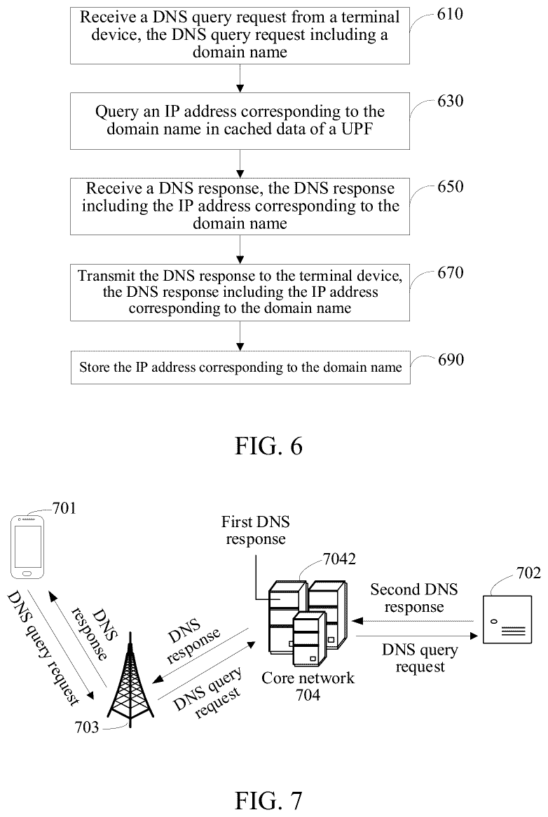

FIG. 6 is a schematic flowchart of a domain name query method according to some embodiments of this application. In this embodiment, an example in which the method is performed by a computer device configured to implement the UPF shown in FIG. 3 is used for description. The method includes at least some of the following operations:

Operation 610: Receive a DNS query request from a terminal device, the DNS query request including a to-be-queried domain name.

The DNS query request is from the terminal device.

The terminal device transmits the DNS query request carrying the to-be-queried domain name to a DNS server, and the DNS server is located in a data network. The DNS query request passes through a network device. The network device is at least one of an access network device or a core network device. The source address of the DNS query request is an address of the terminal device, and a destination address is an address of the DNS server.

In some embodiments, the DNS query request includes at least one of the following:
a UDP-based DNS query request;
a TCP-based DNS query request; or
an HTTP-based DNS query request.

In other words, in some embodiments, the DNS query request is at least one of a UDP DNS query request, a TCP DNS query request, or an HTTP DNS query request.

Operation 630: Query an IP address corresponding to the to-be-queried domain name in cached data of the UPF.

The cached data of the UPF includes data related to a domain name and an IP address corresponding to the domain name.

The cached data of the UPF includes DNS cached data, and the DNS cached data is data related to a mapping relationship between the domain name and the IP address. For example, the UPF queries the IP address corresponding to the to-be-queried domain name in the DNS cached data of the UPF.

In some embodiments, the cached data of the UPF includes at least one of the following:
hot update cached data;
timing cached data;
default cached data;
static cached data; or
dynamic cached data.

Hot update is an update mode of updating in real time without restarting or turning off the device, and the hot update cached data is data cached to the UPF in the hot update mode. The timing cached data is data cached to the UPF within a specified time period, data cached to the UPF in a periodic mode, or data cached to the UPF in a semi-periodic mode. The default cached data is data cached to the UPF in a pre-configured mode or initial cached data in the UPF. The static cached data is data cached to the UPF in a static caching mode. The dynamic cached data is data cached to the UPF in a dynamic caching mode.

Operation 650: Receive a DNS response, the DNS response including the IP address corresponding to the to-be-queried domain name.

If the IP address corresponding to the to-be-queried domain name is not found in the cached data of the UPF, the DNS query request is transmitted to the DNS server. Correspondingly, the DNS response from the DNS server is received, and the DNS server is located in the data network. The DNS response includes the IP address corresponding to the to-be-queried domain name, or the DNS response includes a mapping relationship between the to-be-queried domain name and the IP address.

The UPF receives the DNS response from the data network. The DNS response includes the IP address corresponding to the to-be-queried domain name, or the DNS response includes the mapping relationship between the to-be-queried domain name and the IP address.

For example, the DNS response is generated by the DNS server in the data network. The source address of the DNS response is the address of the DNS server, and a destination address of the DNS response is the address of the terminal device.

Operation 670: Transmit the DNS response to the terminal device, the DNS response including the IP address corresponding to the to-be-queried domain name.

The DNS response is transmitted to the terminal device.

The UPF transmits the DNS response carrying the IP address corresponding to the to-be-queried domain name to the terminal device. For example, the UPF transmits the DNS response carrying the IP address corresponding to the to-be-queried domain name to the access network device, and the access network device transmits the DNS response to the terminal device.

Operation 690: Store the IP address corresponding to the to-be-queried domain name.

The UPF stores, in the cached data of the UPF or the DNS cached data of the UPF, the IP address corresponding to the to-be-queried domain name in the received DNS response. The UPF stores, in the cached data of the UPF or the DNS cached data of the UPF, the mapping relationship between the to-be-queried domain name and the IP address in the received DNS response.

In conclusion, according to the method provided in this application, in a case that cached data of a UPF does not include an IP address corresponding to a to-be-queried domain name, a DNS query request is transmitted to a DNS server, so that the DNS server performs domain name query corresponding to the DNS query request. Then, the IP address that is corresponding to the to-be-queried domain name and that is found by the DNS server is stored in the cached data of the UPF. In other words, a correspondence between the to-be-queried domain name and the IP address is stored in the cached data of the UPF. In this way, correspondences between domain names and IP addressed stored in the cached data of the UPF can be enriched, so that a computer device configured to implement the UPF can directly respond more DNS query requests subsequently, thereby improving speed and efficiency of the domain name query and reducing a processing load of a DNS server in a public network.

FIG. 7 is a schematic diagram of a domain name query method according to some embodiments of this application. An example in which the domain name query method is implemented in the communication system 200 shown in FIG. 2 is used for description.

A terminal device 701 transmits a DNS query request, and the DNS query request includes a to-be-queried domain name. The destination address of the DNS query request is the address of a DNS server 702, and the DNS server 702 is located in a data network. The DNS query request needs to pass through a network device to reach the DNS server 702. The network device includes an access network 703 and a core network 704.

A UPF 7042 (that is, a computer device implementing a UPF) receives the DNS query request, and determines, based on cached data of the UPF 7042, an IP address corresponding to the to-be-queried domain name. The UPF 7042 is located in the core network 704.

The UPF 7042 transmits a DNS response to the terminal device 701, and the DNS response includes the IP address corresponding to the to-be-queried domain name. The DNS response needs to pass through the access network 703 to reach the terminal device 701.

The DNS response is generated by the UPF 7042 or the DNS server 702.

If the DNS response is generated by the UPF 7042, before the UPF 7042 transmits the DNS response to the terminal device 701, the UPF 7042 generates the DNS response based on the IP address corresponding to the to-be-queried domain name in the cached data of the UPF 7042. For distinction, the DNS response generated by the UPF 7042 is referred to as a first DNS response.

If the DNS response is generated by the DNS server 702, after receiving the DNS query request, the UPF 7042 transmits the DNS query request to the DNS server 702, and receives the DNS response returned by the DNS server 702. In addition, the UPF 7042 stores, in the cached data of the UPF 7042, a mapping relationship between the to-be-queried domain name and the IP address in the DNS response. For distinction, the DNS response generated by the DNS server 702 is referred to as a second DNS response.

In conclusion, according to the method provided in this application, in a case that cached data of a UPF does not include an IP address corresponding to a to-be-queried domain name, a DNS query request can be transmitted to a DNS server, so that the DNS server performs domain name query corresponding to the DNS query request. Then, the IP address that is corresponding to the to-be-queried domain name and that is found by the DNS server is stored in the cached data of the UPF. In other words, a correspondence between the to-be-queried domain name and the IP address is stored in the cached data of the UPF. In this way, correspondences between domain names and IP addressed stored in the cached data of the UPF can be enriched, so that a computer device configured to implement the UPF can directly respond more DNS query requests subsequently, thereby improving speed and efficiency of the domain name query and reducing a processing load of a DNS server in a public network.

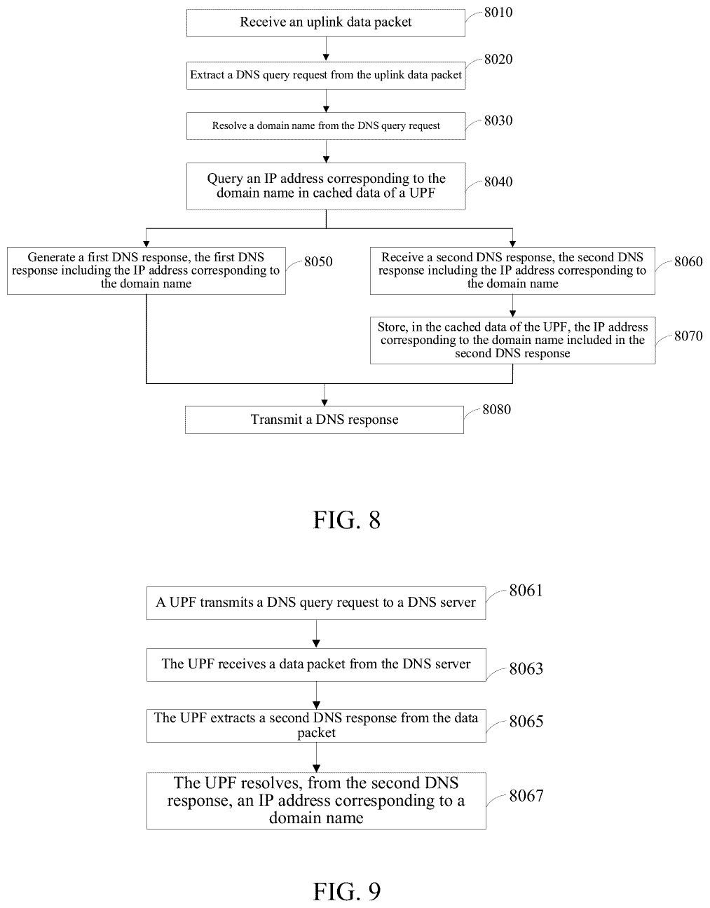

FIG. 8 is a schematic flowchart of a domain name query method according to some embodiments of this application. In this embodiment, an example in which the method is performed by a computer device configured to implement the UPF shown in FIG. 3 is used for description. The method includes at least some of the following operations:

Operation 8010: Receive an uplink data packet transmitted from a terminal device.

The UPF receives the uplink data packet from the terminal device, and the destination address of the uplink data packet is an address of a DNS server. The DNS server is located in a data network, the UPF is located in a core network, and the data network is connected to the core network.

The terminal device expects or needs to obtain an IP address corresponding to a domain name, carries a DNS query request in the uplink data packet, and transmits the uplink data packet to a network device. The DNS query request is configured for requesting to query the IP address corresponding to the domain name. The DNS query request may also be referred to as a DNS resolution request.

The domain name corresponding to the IP address that the terminal device expects or needs to obtain is a to-be-queried domain name, or in other words, the domain name that the terminal device expects or needs to query is a to-be-queried domain name.

In some embodiments, the DNS query request includes at least one of the following:
a UDP-based DNS query request;
a TCP-based DNS query request; or
an HTTP-based DNS query request.

In other words, the DNS query request is at least one of a UDP DNS query request, a TCP DNS query request, or an HTTP DNS query request.

In some embodiments, the terminal device transmits the uplink data packet to an access network device, and the access network device forwards the uplink data packet to the UPF. The access network device transmits the uplink data packet to the core network, and after interaction of functional entities in the core network, the uplink data packet is transmitted to the UPF.

Operation 8020: Extracting the DNS query request from the uplink data packet.

A DNS request module detects, based on at least one of a destination address or a destination port of a message in the uplink data packet, whether the uplink data packet includes the DNS query request.

In a case that the destination address of the message in the uplink data packet is the DNS server in the data network or the destination port of the message in the uplink data packet is consistent with a port of a DNS resolution protocol, the DNS query request is detected by the UPF in the uplink data packet. The DNS resolution protocol includes at least one of a UDP, a TCP, or an HTTP.

The data network includes at least one of the Internet, a wide area network (WAN), a local area network (LAN), or a private network.

The DNS server in the data network is a public domain name resolution server; the DNS server in the data network is a domain name resolution server in a public network; the DNS server in the data network is a domain name resolution server in a wide area network; the DNS server in the data network is a domain name resolution server in a local area network; or the DNS server in the data network is a domain name resolution server in a private network.

An IP address of the DNS server in the data network is configured, or pre-configured, or pre-defined, or is pre-defined in a communication protocol.

Operation 8030: Resolve the to-be-queried domain name from the DNS query request.

In some embodiments, the UPF processes the DNS query requests by using a domain name query model.

The UPF inputs at least one of information such as the to-be-queried domain name, an IP address of the terminal device, time of receiving the DNS query request, an identifier of a local area network to which the terminal device belongs into the domain name query model for processing, to obtain a recommended processing mode for the DNS query request. The UPF processes the DNS query request based on the recommended processing mode.

For example, when the time of receiving the DNS query request falls within a busy time period, the recommended processing mode obtained by using the domain name query model is that the UPF generates a DNS response, and at least subsequent Operation 8040, Operation 8050, and Operation 8080 are performed. When the time of receiving the DNS query request falls within an idle time period, the recommended processing mode obtained by using the domain name query model is that the DNS server generates a DNS response, and at least subsequent Operation 8060, Operation 8070, and Operation 8080 are performed.

The busy time period is a time period that the UPF is in a busy state, and this time period is obtained through prediction by using the domain name query model based on a historical DNS query request. For example, the domain name query model is obtained through prediction, based on time of processing the historical DNS query request, of a time period when the UPF is in the busy state. If the time of processing the historical DNS query request is greater than a first time threshold, it indicates that the UPF is in the busy state, and if the time of processing the historical DNS query request is less than the first time threshold, it indicates the UPF is in a non-busy state.

The idle time period is a time period that the UPF is in an idle state, and this time period is obtained through prediction by using the domain name query model based on a historical DNS query request. For example, the domain name query model obtains through prediction, based on time of processing the historical DNS query request, of a time period when the UPF is in the idle state. If the time of processing the historical DNS query request is less than a second time threshold, it indicates that the UPF is in the idle state, and if the time of processing the historical DNS query request is greater than the second time threshold, it indicates the UPF is in a non-idle state.

The first time threshold and the second time threshold may be the same or may be different. The first time threshold is pre-defined, or pre-configured, or autonomously determined by the UPF, or indicated by the DNS server. The second time threshold is pre-defined, or pre-configured, or autonomously determined by the UPF, or indicated by the DNS server.

For example, when the identifier of the local area network to which the terminal device belongs is a first identifier, the recommended processing mode obtained by using the domain name query model is that the DNS server generates a DNS response, and at least subsequent Operation 8060, Operation 8070, and Operation 8080 are performed. When the identifier of the local area network to which the terminal device belongs is a second identifier, the recommended processing mode obtained by using the domain name query model is that the UPF generates a DNS response, and at least subsequent Operation 8040, Operation 8050, and Operation 8080 are performed.

The first identifier is obtained through prediction by using the domain name query model based on the historical DNS query request. For example, the domain name query model obtains the first identifier through predicting based on a mode for processing the historical DNS query request (whether the DNS response corresponding to the terminal device in a specific local area network is generated by the UPF or generated by the DNS server). The identifier of the local area network to which the terminal device belongs being the first identifier indicates that a probability of the IP address corresponding to the to-be-queried domain name from the terminal device in the local area network being included in the cached data of the UPF is lower than a first probability threshold. In other words, there is a high probability that the cached data of the UPF does not include the IP address corresponding to the to-be-queried domain name of the terminal device in the local area network.

The second identifier is obtained through prediction by using the domain name query model based on the historical DNS query request. For example, the domain name query model obtains the second identifier through predicting based on a mode for processing the historical DNS query request (whether the DNS response corresponding to the terminal device in a specific local area network is generated by the UPF or generated by the DNS server). The identifier of the local area network to which the terminal device belongs being the second identifier indicates that a probability of the IP address corresponding to the to-be-queried domain name from the terminal device in the local area network being included in the cached data of the UPF is higher than a second probability threshold. In other words, there is a high probability that the cached data of the UPF includes the IP address corresponding to the to-be-queried domain name of the terminal device in the local area network.

The first probability threshold and the second probability threshold may be the same or may be different. The first probability threshold is pre-defined, or pre-configured, or autonomously determined by the UPF, or indicated by the DNS server. The second probability threshold is pre-defined, or pre-configured, or autonomously determined by the UPF, or indicated by the DNS server.

Operation 8040: Query the IP address corresponding to the to-be-queried domain name in the cached data of the UPF.

The cached data of the UPF is from the DNS server, and the DNS server is located in the data network.

The cached data of the UPF includes data related to a domain name and an IP address corresponding to the domain name.

The cached data of the UPF includes DNS cached data, and the DNS cached data is data related to a mapping relationship between the domain name and the IP address. For example, the UPF queries the IP address corresponding to the to-be-queried domain name in the DNS cached data of the UPF, or in other words, the UPF queries the mapping relationship between the to-be-queried domain name and the IP address in the DNS cached data of the UPF.

Operation 8050: Generate a first DNS response, the first DNS response including the IP address corresponding to the to-be-queried domain name.

The cached data of the UPF includes the IP address corresponding to the to-be-queried domain name, or in other words, the cached data of the UPF includes the mapping relationship between the to-be-queried domain name and the IP address.

The DNS cached data of the UPF includes the IP address corresponding to the to-be-queried domain name, or in other words, the DNS cached data of the UPF includes the mapping relationship between the to-be-queried domain name and the IP address.

The UPF generates the first DNS response based on the identified IP address corresponding to the to-be-queried domain name. The UPF generates the first DNS response based on the mapping relationship between the identified IP address and the to-be-queried domain name.

Operation 8060: Receive a second DNS response, the second DNS response including the IP address corresponding to the to-be-queried domain name.

In some embodiments, the cached data of the UPF does not include the IP address corresponding to the to-be-queried domain name, or in other words, the cached data of the UPF does not include the mapping relationship between the to-be-queried domain name and the IP address.

In some embodiments, the DNS cached data of the UPF does not include the IP address corresponding to the to-be-queried domain name, or in other words, the DNS cached data of the UPF does not include the mapping relationship between the to-be-queried domain name and the IP address.

In some embodiments, the UPF receives the second DNS response from the data network. A source address of the second DNS response is the address of the DNS server, and a destination address is an address of the terminal device.

Operation 8070: Store, in the cached data of the UPF, the IP address corresponding to the to-be-queried domain name included in the second DNS response.

In some embodiments, the UPF stores, in the cached data of the UPF, the mapping relationship between the to-be-queried domain name and the IP address included in the second DNS response.

Operation 8080: Transmit a DNS response.

The DNS response is the first DNS response or the second DNS response.

In some embodiments, the DNS response includes the IP address corresponding to the to-be-queried domain name, or the DNS response includes the mapping relationship between the to-be-queried domain name and the IP address.

In some embodiments, the UPF transmits the DNS response to the access network device, and the access network device forwards the DNS response to the terminal device.

In conclusion, according to the method provided in this application, an uplink data packet transmitted from a terminal device to a DNS server is resolved, to obtain a DNS query request and a to-be-queried domain name in the DNS query request. In a case that cached data of a UPF includes an IP address corresponding to the to-be-queried domain name, domain name query corresponding to the DNS query request may be directly completed based on the cached data of the UPF, to obtain the IP address corresponding to the to-be-queried domain name and feedback the IP address corresponding to the to-be-queried domain name to the terminal device, so that compared with transmitting the DNS query request to a DNS server in a public network, a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced. In a case that the cached data of the UPF does not include the IP address corresponding to the to-be-queried domain name, a computer device configured to implement the UPF may transmit the DNS query request to the DNS server, receive a data packet fed back correspondingly by the DNS server, extract a DNS response from the data packet, resolve, from the DNS response, the IP address corresponding to the to-be-queried domain name, and then store, in the cached data of the UPF, a correspondence between the to-be-queried domain name and the IP address. In this way, the domain name query can be ensured to be implemented reliably, and correspondences between domain names and IP addressed stored in the cached data of the UPF can be enriched, so that the computer device configured to implement the UPF can directly respond more DNS query requests subsequently, thereby improving speed and efficiency of the domain name query and reducing a processing load of the DNS server in the public network.

In some embodiments, the foregoing operation 8060 may be implemented as at least some of the following Operation 8061, Operation 8063, Operation 8065, and Operation 8067, as shown in FIG. 9. In this embodiment, the computer device configured to implement the UPF is referred to as a UPF for short.

Operation 8061: The UPF transmits the DNS query request to the DNS server.

The DNS query request includes the to-be-queried domain name from the terminal device.

In some embodiments, the DNS server is located in the data network.

In some embodiments, the data network includes at least one of the Internet, a WAN, an LAN, or a private network.

Operation 8063: The UPF receives a data packet from the DNS server.

In some embodiments, the DNS server transmits a second DNS response to the UPF.

In some embodiments, the DNS server transmits a second DNS response to the core network, and after interaction of functional entities in the core network, the second DNS response is transmitted to the UPF.

In some embodiments, the DNS server carries a second DNS response in the data packet and transmits the data packet to the core network.

In some embodiments, the DNS server transmits the data packet to the core network, and after interaction of functional entities in the core network, the data packet is transmitted to the UPF. The data packet includes the second DNS response.

In some embodiments, the DNS server queries, based on the to-be-queried domain name included in the received DNS query request, the IP address corresponding to the to-be-queried domain name or the mapping relationship between the to-be-queried domain name and the IP address.

In some embodiments, the DNS server generates the second DNS response based on the identified IP address corresponding to the to-be-queried domain name or based on the found mapping relationship between to-be-queried domain name and the IP address.

In some embodiments, the DNS server generates the second DNS response.

In some embodiments, the DNS server is a DNS server in the data network.

In some embodiments, the DNS server in the data network is a public domain name resolution server; the DNS server in the data network is a domain name resolution server in a public network; the DNS server in the data network is a domain name resolution server in a wide area network; the DNS server in the data network is a domain name resolution server in a local area network; or the DNS server in the data network is a domain name resolution server in a private network.

Operation 8065: The UPF extracts the second DNS response from the data packet.

The UPF detects the data packet and detects the second DNS response from the data packet.

Operation 8067: The UPF resolves, from the second DNS response, the IP address corresponding to the to-be-queried domain name.

In some embodiments, the UPF resolves the second DNS response and obtains the mapping relationship between the to-be-queried domain name and the IP address.

In some embodiments, some or all of the foregoing operations performed by the UPF are performed by a UPF basic module in the UPF.

In some embodiments, the UPF basic module in the UPF is configured to implement a basic function of the UPF; the UPF basic module in the UPF is configured to implement a function of not directly processing domain name query; or the UPF basic module in the UPF is configured to implement a function of processing domain name query.

In some embodiments, some or all of the foregoing operations performed by the UPF are performed by a DNS module in the UPF.

In some embodiments, the DNS module in the UPF is configured to implement a non-basic function of the UPF; or the DNS module in the UPF is configured to implement a function related to domain name query processing.

In some embodiments, the DNS module in the UPF includes at least one of a DNS request module, a DNS cache module, and a DNS response module.

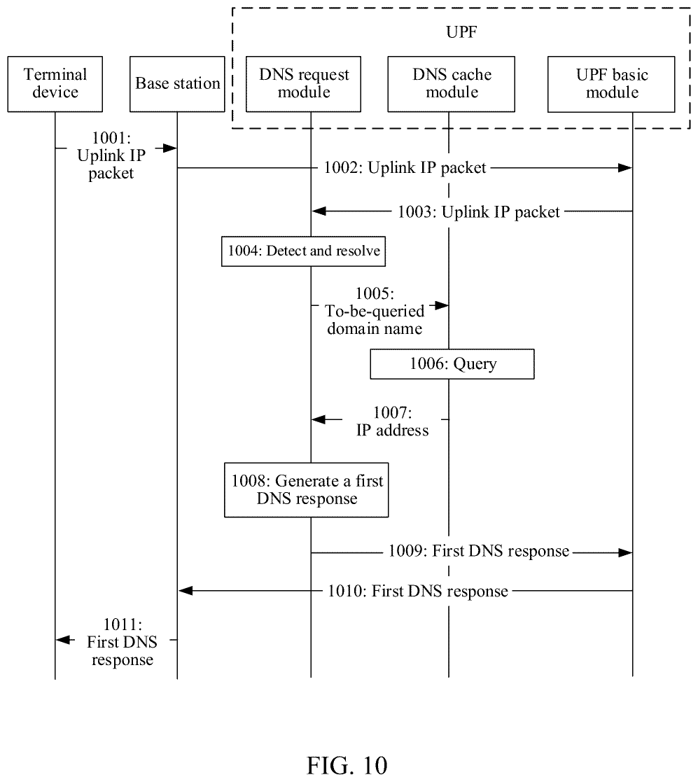

FIG. 10 is a schematic flowchart of a domain name query method according to some embodiments of this application. In this embodiment, an example in which the method is performed by the communication system 200 shown in FIG. 2 and a computer device configured to implement a UPF includes at least a UPF basic module, a DNS request module, and a DNS cache module is used for description. The method includes at least some of the following operations:

Operation 1001: A terminal device transmits an uplink IP packet to a base station.

An example in which a domain name that the terminal device expects or needs to query is an Internet service domain name is used.

The terminal device starts to access an Internet service, carries a DNS query request in the uplink IP packet, and transmits the uplink IP packet to a network device. The source address of the uplink IP packet is an address of the terminal device, and a destination address is an address of a DNS server. The DNS server is located in a data network. The DNS query request is configured for requesting to query an IP address corresponding to the Internet service domain name. The DNS query request may also be referred to as a DNS resolution request. The Internet service domain name is a to-be-queried domain name.

In some embodiments, the DNS query request includes at least one of the following:
a UDP-based DNS query request;
a TCP-based DNS query request; or
an HTTP-based DNS query request.

In other words, in some embodiments, the DNS query request is at least one of a UDP DNS query request, a TCP DNS query request, or an HTTP DNS query request.

In some embodiments, the uplink IP packet includes the DNS query request and an IP address of the terminal device, and the DNS query request includes the to-be-queried domain name.

Operation 1002: The base station forwards the uplink IP packet to the UPF.

In other words, the base station serves as an access network device and forwards the uplink IP packet from the terminal device to a core network, and finally, the uplink IP packet reaches the UPF in the core network.

Operation 1003: The UPF basic module receives the uplink IP packet and forwards the uplink IP packet to the DNS request module.

Operation 1004: The DNS request module detects the uplink IP packet and resolves the DNS query request.

In some embodiments, the DNS request module (DNS Request Filter, DNS-Req Filter) is configured to detect and resolve the DNS query request, and is responsible for detecting the DNS query request from the uplink IP packet, and resolving the DNS query request to obtain a domain name field in the DNS query request, so as to obtain the to-be-queried domain name in the DNS query request. The DNS request module detects and resolved the DNS query request in the uplink IP packet, so that the DNS query request can be processed before reaching the DNS server. In this way, resource consumption of a communication link section from the DNS request module to the DNS server can be reduced, and time of processing the DNS query request can be saved, thereby improving efficiency of processing the DNS query request.

In some embodiments, the DNS request module detects, based on at least one of the destination address or a destination port of the uplink IP packet, whether the uplink IP packet includes the DNS query request.

In some embodiments, in a case that the destination address of the uplink IP packet is the DNS server in the data network or the destination port of the uplink IP packet is consistent with a port of a DNS resolution protocol, the DNS request module detects the DNS query request in the uplink IP packet. The DNS resolution protocol includes at least one of a UDP, a TCP, or an HTTP.

For example, if the destination address of the uplink IP packet is a DNS server (with an IP address of 8.8.8.8 or 114.114.114.114) of a public network, and a destination port of a UDP packet carried by the DNS query request is 53, it is determined that the uplink IP packet includes the DNS query request, in other words, the DNS query request is detected in the uplink IP packet.

In some embodiments, an IP address of the DNS server in the data network is configured, or pre-configured, or pre-defined, or is pre-defined in a communication protocol.

In some embodiments, the IP address of the DNS server in the data network is not just an IP address (for example, 8.8.8.8 or 114.114.114.114) of a DNS server of a general public network.

Operation 1005: The DNS request module transmits the to-be-queried domain name to the DNS cache module.

Operation 1006: The DNS cache module queries an IP address corresponding to a domain name.

In some embodiments, the DNS cache module (DNS Cache) is configured to query and cache a mapping relationship between the domain name and the IP address. In other words, the DNS cache module is configured to query and cache the IP address corresponding to the domain name.

In some embodiments, the DNS cache module receives a domain name query request transmitted from the DNS request module, and completes query of the mapping relationship between the domain name and the IP address, or completes the query of the IP address corresponding to the domain name.

In some embodiments, the domain name query request transmitted from the DNS request module may be considered as a local domain name query request of the UPF.

In some embodiments, the query of the mapping relationship between the domain name and the IP address may also be considered as retrieval of the mapping relationship between the domain name and the IP address. The query of the IP address corresponding to the domain name may also be considered as a search for the IP address corresponding to the domain name.

In some embodiments, the DNS cache module queries or retrieves the mapping relationship between the domain name and the IP address in DNS cached data of the UPF, or the DNS cache module queries or retrieves the IP address corresponding to the domain name in the DNS cached data of the UPF.

In some embodiments, cached data of the UPF or the DNS cached data of the UPF includes at least one of hot update cached data, timing cached data, default cached data, static cached data, or dynamic cached data, to maintain good synchronization between the cached data of the UPF and a change of a DNS service in the data network, so that the cached data of the UPF has good timeliness.

In some embodiments, if the cached data of the UPF or the DNS cached data of the UPF includes the IP address corresponding to the to-be-queried domain name or includes a mapping relationship between the to-be-queried domain name and the IP address, Operation 1007 is performed.

Operation 1007: The DNS cache module transmits the IP address corresponding to the to-be-queried domain name to the DNS request module.

In some embodiments, the DNS cache module transmits the found or retrieved mapping relationship between the to-be-queried domain name and the IP address to the DNS request module, or the DNS cache module transmits the found or retrieved IP address corresponding to the to-be-queried domain name to the DNS request module. In other words, the DNS cache module returns the found or retrieved mapping relationship between the to-be-queried domain name and the IP address to the DNS request module, or the DNS cache module returns the found or retrieved IP address corresponding to the to-be-queried domain name to the DNS request module.

Operation 1008: The DNS request module generates a first DNS response.

The DNS request module generates the first DNS response based on the IP address corresponding to the to-be-queried domain name from the DNS cache module, or based on the mapping relationship between the to-be-queried domain name and the IP address from the DNS cache module. The first DNS response includes the IP address corresponding to the to-be-queried domain name. The DNS request module generates a DNS response, so that the DNS query request can be processed before reaching the DNS server. In this way, resource consumption of a communication link section from the DNS request module to the DNS server can be reduced, resource consumption of processing the DNS query request by the DNS server can be reduced, and time of processing the DNS query request can be saved, thereby improving efficiency of processing the DNS query request.

Operation 1009: The DNS request module transmits the first DNS response to the UPF basic module.

In some embodiments, the DNS request module transmits a data packet of the first DNS response to the UPF basic module.

Operation 1010: The UPF basic module transmits the first DNS response to the base station.

In some embodiments, the UPF basic module processes the first DNS response, for example, packages the first DNS response, and transmits a processed first DNS response to the terminal device.

In some embodiments, the UPF basic module transmits the first DNS response to the access network, for example, the base station, through a tunnel, and the access network transmits the first DNS response to the terminal device.

Operation 1011: The base station transmits the first DNS response to the terminal device.

In some embodiments, the terminal device accesses the Internet service based on the received first DNS response through the IP address corresponding to the to-be-queried domain name included in the first DNS response.

In some embodiments, the UPF basic module, the DNS request module, and the DNS cache module implement corresponding functions by using software or a program.

In some embodiments, the UPF basic module, the DNS request module, and the DNS cache module are considered as part or all of the entire UPF.

In conclusion, according to the method provided in this application, domain name query can be implemented by a UPF basic module, a DNS request module, and a DNS cache module in a UPF. Compared with a method in related art where a DNS query request is transmitted to a DNS server of a public network through a long network communication link, in the method provided in this application, before a DNS query request is transmitted to a DNS server of a public network, domain name query corresponding to the DNS query request can be completed based on cached data of the UPF, so that a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced. Furthermore, the method provided in this embodiment can be implemented by an existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented.

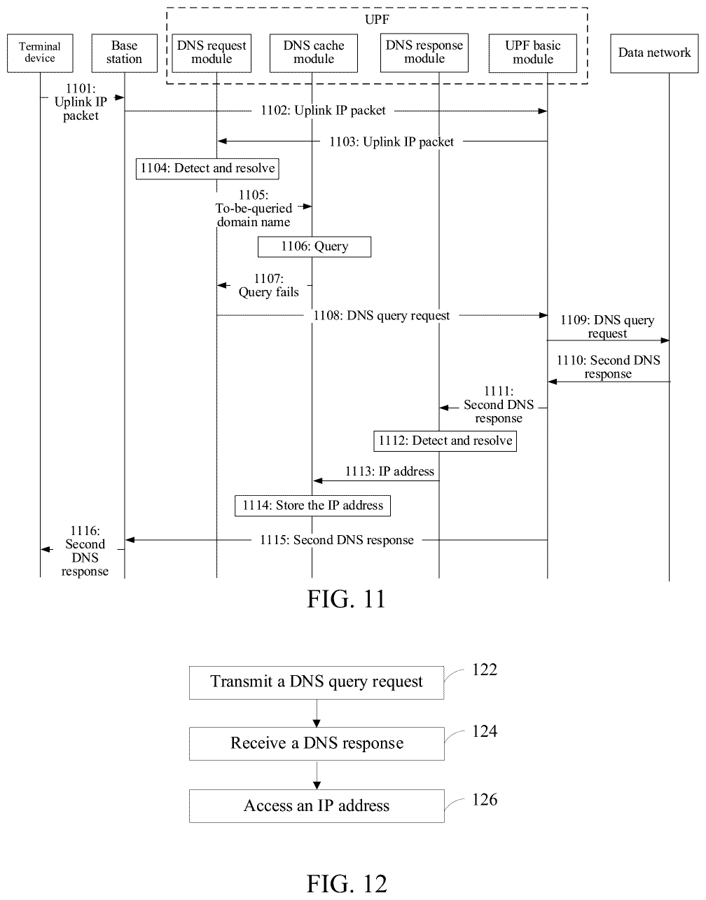

FIG. 11 is a schematic flowchart of a domain name query method according to some embodiments of this application. In this embodiment, an example in which the method is performed by a computer device configured to implement the UPF shown in FIG. 3 and the UPF includes at least a UPF basic module, a DNS request module, a DNS cache module, and a DNS response module is used for description. The method includes at least some of the following operations:

Operation 1101: A terminal device transmits an uplink IP packet to a base station.

An example in which a domain name that the terminal device expects or needs to query is an Internet service domain name is used.

The terminal device starts to access an Internet service, carries a DNS query request in the uplink IP packet, and transmits the uplink IP packet to a network device. The source address of the uplink IP packet is an address of the terminal device, and a destination address is an address of a DNS server. The DNS server is located in a data network. The DNS query request is configured for requesting to query an IP address corresponding to the Internet service domain name. The DNS query request may also be referred to as a DNS resolution request. The Internet service domain name is a to-be-queried domain name.

In some embodiments, the DNS query request includes at least one of the following:
a UDP-based DNS query request;
a TCP-based DNS query request; or
an HTTP-based DNS query request.

In other words, in some embodiments, the DNS query request is at least one of a UDP DNS query request, a TCP DNS query request, or an HTTP DNS query request.

In some embodiments, the uplink IP packet includes the DNS query request and an IP address of the terminal device, and the DNS query request includes the to-be-queried domain name.

Operation 1102: The base station forwards the uplink IP packet to the UPF.

In other words, the base station serves as an access network device and forwards the uplink IP packet from the terminal device to a core network, and finally, the uplink IP packet reaches the UPF in the core network.

Operation 1103: The UPF basic module receives the uplink IP packet and forwards the uplink IP packet to the DNS request module.

Operation 1104: The DNS request module detects the uplink IP packet and resolves the DNS query request.

In some embodiments, the DNS request module is configured to detect and resolve the DNS query request, and is responsible for detecting the DNS query request from the uplink IP packet, and resolving the DNS query request to obtain a domain name field in the DNS query request, so as to obtain the to-be-queried domain name in the DNS query request.

In some embodiments, the DNS request module detects, based on at least one of the destination address or a destination port of the uplink IP packet, whether the uplink IP packet includes the DNS query request.

In some embodiments, in a case that the destination address of the uplink IP packet is the DNS server in the data network or the destination port of the uplink IP packet is consistent with a port of a DNS resolution protocol, the DNS request module detects the DNS query request in the uplink IP packet. The DNS resolution protocol includes at least one of a UDP, a TCP, or an HTTP.

For example, if the destination address of the uplink IP packet is a DNS server (with an IP address of 8.8.8.8 or 114.114.114.114) of a public network, and a destination port of a UDP packet carried by the DNS query request is 53, it is determined that the uplink IP packet includes the DNS query request, in other words, the DNS query request is detected in the uplink IP packet.

In some embodiments, an IP address of the DNS server in the data network is configured, or pre-configured, or pre-defined, or is pre-defined in a communication protocol.

In some embodiments, the IP address of the DNS server in the data network is not just an IP address (for example, 8.8.8.8 or 114.114.114.114) of a DNS server of a general public network.

Operation 1105: The DNS request module transmits the to-be-queried domain name to the DNS cache module.

Operation 1106: The DNS cache module queries an IP address corresponding to a domain name.

In some embodiments, the DNS cache module is configured to query and cache a mapping relationship between the domain name and the IP address. In other words, the DNS cache module is configured to query and cache the IP address corresponding to the domain name.

In some embodiments, the DNS cache module receives a domain name query request transmitted from the DNS request module, and queries the mapping relationship between the domain name and the IP address, or queries the IP address corresponding to the domain name.

In some embodiments, the domain name query request transmitted from the DNS request module may be considered as a local domain name query request of the UPF.

In some embodiments, the query of the mapping relationship between the domain name and the IP address may also be considered as retrieval of the mapping relationship between the domain name and the IP address. The query of the IP address corresponding to the domain name may also be considered as a search for the IP address corresponding to the domain name.

In some embodiments, the DNS cache module queries or retrieves the mapping relationship between the domain name and the IP address in DNS cached data of the UPF, or the DNS cache module queries or retrieves the IP address corresponding to the domain name in the DNS cached data of the UPF.

In some embodiments, cached data of the UPF or the DNS cached data of the UPF includes at least one of hot update cached data, timing cached data, default cached data, static cached data, or dynamic cached data, to maintain good synchronization between the cached data of the UPF and a change of a DNS service in the data network, so that update of the cached data of the UPF has good timeliness.

In some embodiments, if the cached data of the UPF or the DNS cached data of the UPF does not include the IP address corresponding to the to-be-queried domain name, in other words, if the IP address corresponding to the domain name or the mapping relationship between the domain name and the IP address is not found by the UPF in the cached data of the UPF or the DNS cached data of the UPF, Operation 1107 is performed.

Operation 1107: The DNS cache module transmits query failure feedback information to the DNS request module.

In some embodiments, if the mapping relationship between the to-be-queried domain name and the IP address is not found or retrieved by the DNS cache module, or if the IP address corresponding to the to-be-queried domain name is not found or retrieved by the DNS cache module, the DNS cache module does not return a domain name query result to the DNS request module, or the DNS cache module returns a query failure result to the DNS request module. The query failure result includes failure of querying the mapping relationship of the to-be-queried domain name and the IP address, or failure of querying the IP address corresponding to the to-be-queried domain name.

In some embodiments, if the mapping relationship between the to-be-queried domain name and the IP address is not found or retrieved, or if the IP address corresponding to the to-be-queried domain name is not found or retrieved, the DNS cache module transmits the query failure feedback information to the DNS request module. The query failure feedback information is configured for indicating query failure of the DNS cache module and includes: the DNS cache module fails to query the mapping relationship between the to-be-queried domain name and the IP address; the DNS cache module fails to query the IP address corresponding to the to-be-queried domain name; the mapping relationship between the to-be-queried domain name and the IP address is not found by the DNS cache module in the cached data of the UPF; the IP address corresponding to the to-be-queried domain name is not found by the DNS cache module in the cached data of the UPF; the mapping relationship between the to-be-queried domain name and the IP address is not found by the DNS cache module in the DNS cached data; or the IP address corresponding to the to-be-queried domain name is not found by the DNS cache module in the DNS cached data.

Operation 1108: The DNS request module transmits the DNS query request to the UPF basic module.

In some embodiments, if the DNS request module receives the query failure result or the query failure feedback information from the DNS cache module, the DNS request module transmits the DNS query request to the UPF basic module.

In some embodiments, if the mapping relationship that is between the to-be-queried domain name and the IP address and that is transmitted from the DNS cache module is not received by the DNS request module within first duration, or if the IP address that is corresponding to the to-be-queried domain name and that is transmitted from the DNS cache module is not received by the DNS request module within first duration, the DNS request module transmits the DNS query request to the UPF basic module.

In some embodiments, the first duration is configured, or pre-configured, or pre-defined.

Operation 1109: The UPF basic module transmits a DNS query request to the data network.

In some embodiments, the UPF basic module transmits the DNS query request to the DNS server in the data network.

Operation 1110: The UPF basic module receives a second DNS response.

The second DNS response includes the IP address corresponding to the to-be-queried domain name and the is from the data network. The source address of the second DNS response is the address of the DNS server, and a destination address is the address of the terminal device.

In some embodiments, the DNS server in the data network generates the second DNS response.

In some embodiments, the data network carries the second DNS response in a downlink IP packet for transmission. The source address of the downlink IP packet is the address of the DNS server, and a destination address is the address of the terminal device.

In some embodiments, the data network transmits the downlink IP packet including (or carrying) the second DNS response to the core network, and the downlink IP packet including (or carrying) the second DNS response reaches the UPF in the core network.

In some embodiments, the data network includes at least one of the Internet, a WAN, an LAN, or a private network.

In some embodiments, the data network queries, based on the to-be-queried domain name included in the received DNS query request, the IP address corresponding to the to-be-queried domain name or the mapping relationship between the to-be-queried domain name and the IP address.

In some embodiments, the data network generates the second DNS response based on the identified IP address corresponding to the to-be-queried domain name or based on the found mapping relationship between to-be-queried domain name and the IP address.

In some embodiments, the DNS server in the data network is a public domain name resolution server; the DNS server in the data network is a domain name resolution server in a public network; the DNS server in the data network is a domain name resolution server in a wide area network; the DNS server in the data network is a domain name resolution server in a local area network; or the DNS server in the data network is a domain name resolution server in a private network.

Operation 1111: The UPF basic module transmits the second DNS response to the DNS response module.

In some embodiments, the UPF basic module transmits the downlink IP packet including (or carrying) the second DNS response to the DNS response module, or the UPF basic module transmits the downlink IP packet including (or carrying) the second DNS response to the DNS response module.

Operation 1112: The DNS response module detects the second DNS response and resolves the second DNS response.

In some embodiments, the DNS response module (DNS Response Filter, DNS-Resq Filter) is configured to detect and resolve a DNS response.

In some embodiments, the DNS response module detects, based on at least one of the source address or a source port of the downlink IP packet, whether the downlink IP packet includes the DNS response.

In some embodiments, in a case that if the source address of the downlink IP packet is the DNS server in the data network or the source port of the downlink IP packet is consistent with a port of a DNS resolution protocol, the DNS response module detects the DNS response in the downlink IP packet. The DNS resolution protocol includes at least one of a UDP, a TCP, or an HTTP.

For example, if the source address of the downlink IP packet is a DNS server (with an IP address of 8.8.8.8 or 114.114.114.114) of a public network, and a source port of a UDP packet carried by the DNS response is 53, it is determined that the downlink IP packet includes the DNS response, in other words, the DNS response is detected in the downlink IP packet.

In some embodiments, an IP address of the DNS server in the data network is configured, or pre-configured, or pre-defined, or is pre-defined in a communication protocol.

In some embodiments, the IP address of the DNS server in the data network is not just an IP address (for example, 8.8.8.8 or 114.114.114.114) of a DNS server of a general public network.

In some embodiments, the DNS response module resolves the second DNS response, and obtains a domain name and an IP address corresponding to the domain name in the DNS response, or obtains a mapping relationship between a domain name and an IP address in the DNS response. The domain name in the DNS response includes the Internet service domain name in Operation 1101.

Operation 1113: The DNS response module transmits the IP address corresponding to the domain name to the DNS cache module.

In some embodiments, the DNS response module transmits the domain name and the IP address corresponding to the domain name obtained through resolution, or the DNS response module transmits the mapping relationship that is between the domain name and the IP address and that is obtained through resolution to the DNS cache module.

Operation 1114: The DNS cache module stores the IP address corresponding to the domain name.

In some embodiments, the DNS cache module stores the domain name and the IP address corresponding to the domain name that are received, or the DNS cache module stores the received mapping relationship between the domain name and the IP address.

In some embodiments, the DNS cache module stores, in the cached data of the UPF, the domain name and the IP address corresponding to the domain name that are received or the mapping relationship between the domain name and the IP address.

In some embodiments, the DNS cache module stores, in the DNS cached data, the domain name and the IP address corresponding to the domain name that are received or the mapping relationship between the domain name and the IP address.

In some embodiments, the DNS cache module storing the IP address corresponding to the domain name or the mapping relationship between the domain name and the IP address may be considered as locally storing, in the UPF, the IP address corresponding to the domain name or the mapping relationship between the domain name and the IP address.

The DNS cache module stores, in the cached data of the UPF, the mapping relationship between the domain name and the IP address in the second DNS response, and when the DNS query request is received in the future, the UPF request module processes the DNS query request, so that the DNS query request can be processed before reaching the DNS server. In this way, resource consumption of a communication link section from the DNS request module to the DNS server can be reduced, resource consumption of processing the DNS query request by the DNS server can be reduced, and time of processing the DNS query request can be saved, thereby improving efficiency of processing the DNS query request.

Operation 1115: The UPF basic module transmits the second DNS response to the base station.

The second DNS response includes the IP address corresponding to the to-be-queried domain name.

In some embodiments, the UPF basic module processes the second DNS response, for example, packages the second DNS response, and transmits a processed second DNS response to the terminal device.

In some embodiments, the UPF basic module transmits the second DNS response to the access network, for example, the base station, through a tunnel, and the access network transmits the second DNS response to the terminal device.

Operation 1116: The base station transmits the second DNS response to the terminal device.

In some embodiments, the terminal device accesses the Internet service based on the received second DNS response through the IP address corresponding to the to-be-queried domain name included in the second DNS response.

In some embodiments, the UPF basic module, the DNS request module, and the DNS cache module implement corresponding functions by using software or a program.

In some embodiments, the UPF basic module, the DNS request module, the DNS cache module, and the DNS response module are considered as part or all of the entire UPF.

In conclusion, according to the method provided in this application, domain name query can be performed by a UPF basic module, a DNS request module, a DNS cache module, and a DNS response module in a UPF, and an identified IP address is returned to a terminal device. Compared with a method in related art where a DNS query request is transmitted to a DNS server of a public network through a long network communication link, in the method provided in this application, before a DNS query request is transmitted to a DNS server of a public network, domain name query corresponding to the DNS query request can be completed based on cached data of the UPF, so that a network communication link needed is short, thereby speeding up the domain name query process. In addition, because the DNS query request does not need to reach the DNS server of the public network, the quantity of DNS query requests that need to be processed by the DNS server can be reduced, so that a processing load of the DNS server of the public network is reduced. Furthermore, the method provided in this embodiment can be implemented by an existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented. In addition, according to the method provided in this application, the computer device configured to implement the UPF can store, in the cached data of the UPF, an IP address corresponding to a domain name from a data network. This is beneficial to subsequent processing of the DNS query request by the UPF, and further improves efficiency and speed of the domain name query.

FIG. 12 is a schematic flowchart of a domain name query method according to some embodiments of this application. In this embodiment, an example in which the method is performed by the terminal device shown in FIG. 3 is used for description. The method includes at least some of the following operations:

Operation 122: Transmit a DNS query request.

In some embodiments, the terminal device transmits the DNS query request carrying a to-be-queried domain name to a network device. The network device is an access network device and/or a core network device.

In some embodiments, the DNS query request includes at least one of the following:
a UDP-based DNS query request;
a TCP-based DNS query request; or
an HTTP-based DNS query request.

In other words, in some embodiments, the DNS query request is at least one of a UDP DNS query request, a TCP DNS query request, or an HTTP DNS query request.

Operation 124: Receive a DNS response.

In some embodiments, the terminal device receives a DNS response from the network device. The DNS response carries an IP address corresponding to the to-be-queried domain name.

In some embodiments, the terminal device receives a DNS response from the access network, and the access network receives a DNS response from the core network. The DNS response carries an IP address corresponding to the to-be-queried domain name.

In some embodiments, the DNS response is from a UPF of the core network.

In some embodiments, the DNS response is generated by the UPF of the core network, or the DNS response is generated by a DNS server in a data network.

In some embodiments, the terminal device resolves the DNS response from the network device, and obtains the IP address corresponding to the to-be-queried domain name in the DNS response.

Operation 126: Access the IP address.

In some embodiments, the terminal device accesses, based on the received IP address corresponding to the to-be-queried domain name, the IP address or an Internet service corresponding to the IP address.

In conclusion, according to the method provided in this embodiment, a terminal device can obtain a DNS response from a UPF. Compared with a method in related art where a DNS query request is transmitted to a DNS server of a public network through a long network communication link, in the method provided in this application, before a DNS query request is transmitted to a DNS server of a public network, domain name query corresponding to the DNS query request can be completed based on cached data of a UPF, so that a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced. Furthermore, the method provided in this embodiment can be implemented by an existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented.

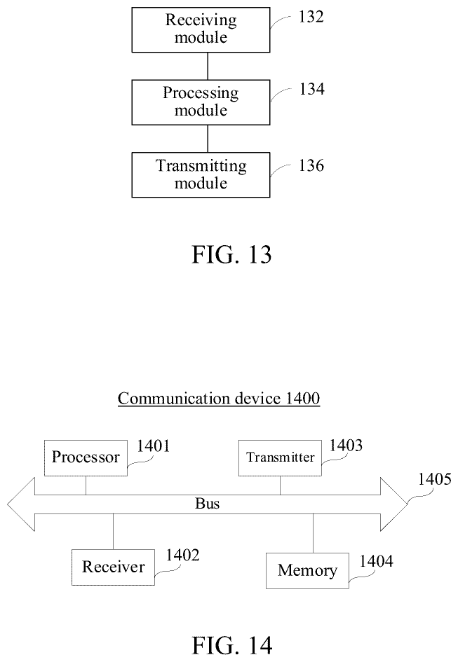

FIG. 13 is a schematic diagram of a structure of a domain name query apparatus according to some embodiments of this application. The apparatus includes at least some modules of a receiving module 132, a processing module 134, or a transmitting module 136.

The receiving module 132 is configured to receive a DNS query request from a terminal device. The DNS query request includes a to-be-queried domain name.

The processing module 134 is configured to determine, based on cached data of the apparatus, an IP address corresponding to the to-be-queried domain name.

The transmitting module 136 is configured to transmit a DNS response to the terminal device. The DNS response includes the IP address corresponding to the to-be-queried domain name.

In some embodiments, the processing module 134 is further configured to generate, in a case that the cached data of the apparatus includes the IP address corresponding to the to-be-queried domain name, the DNS response based on the IP address corresponding to the to-be-queried domain name.

In some embodiments, the apparatus further includes the transmitting module 136. The transmitting module 136 is configured to transmit the DNS query request to a DNS server in a case that the cached data of the apparatus does not include the IP address corresponding to the to-be-queried domain name; and

In some embodiments, the receiving module 132 is further configured to receive the DNS response from the DNS server.

The DNS server is located in a data network, a UPF is located in a core network, and the data network is connected to the core network.

In some embodiments, the processing module 134 is further configured to store, in the cached data of the apparatus, the IP address corresponding to the to-be-queried domain name included in the DNS response.

In some embodiments, the receiving module 132 is further configured to receive a data packet from the DNS server. The destination address of the data packet is an address of the terminal device.

In some embodiments, the processing module 134 is further configured to extract the DNS response from the data packet.

In some embodiments, the processing module 134 is further configured to resolve, from the DNS response, the IP address corresponding to the to-be-queried domain name.

In some embodiments, the receiving module 132 is further configured to receive an uplink data packet transmitted from the terminal device. A destination address of the uplink data packet is an address of the DNS server.

In some embodiments, the processing module 134 is further configured to extract the DNS query request from the uplink data packet.

In some embodiments, the processing module 134 is further configured to resolve the to-be-queried domain name from the DNS query request.

The DNS server is located in the data network, the UPF is located in the core network, and the data network is connected to the core network.

In some embodiments, the cached data of the UPF is from the DNS server, and the DNS server is located in the data network.

In some embodiments, the cached data of the UPF includes at least one of the following:
hot update cached data;
timing cached data;
default cached data;
static cached data; or
dynamic cached data.

In some embodiments, the DNS query request includes at least one of the following:
a user datagram protocol (UDP) based DNS query request;
a transmission control protocol (TCP) based DNS query request; or
a hypertext transfer protocol (HTTP) based DNS query request.

In conclusion, compared with a method in related art where a DNS query request is transmitted to a DNS server of a public network through a long network communication link, according to the apparatus provided in this application, before a DNS query request is transmitted to a DNS server of a public network, domain name query corresponding to the DNS query request can be completed based on cached data of a UPF, so that a network communication link needed is short, thereby speeding up the domain name query. In addition, because the DNS query request does not need to reach the DNS server of the public network, the number of DNS query requests that need to be processed by the DNS server can be reduced, so that a processing load of the DNS server of the public network is reduced. Furthermore, the apparatus provided in this embodiment can be implemented by an existing computer device implementing the UPF, without needing to add additional devices in a core network. Therefore, implementation costs of the method provided in this application are low. Moreover, the existing computer device implementing the UPF is used to perform domain name query, and in this way, no additional offloading rules are needed, so that the method has high compatibility and is easy to be implemented.

For the apparatus provided in the foregoing embodiments, during domain name query, only division of the foregoing function modules is described by using examples. In some embodiments, the foregoing functions are completed by different function modules as required. In other words, the internal structure of the device is divided into different function modules to complete all or some of the functions described above. In addition, for details of a specific implementation process, reference is made to the method embodiments, and details are not described herein again.

FIG. 14 is a block diagram of a structure of a communication device 1400 according to some embodiments of this application. The communication device 1400 includes: a processor 1401, a receiver 1402, a transmitter 1403, a memory 1404, and a bus 1405.

The processor 1401 includes one or more of processing cores, and the processor 1401 runs a software program and a module to perform various functional applications and information processing. In some embodiments, the processor 1401 may be configured to implement functions and operations of the foregoing processing module 134.

The receiver 1402 and the transmitter 1403 may be implemented as a communication component, and the communication component may be a communication chip. In some embodiments, the receiver 1402 may be configured to implement functions and operations of the foregoing receiving module 132. In some embodiments, the transmitter 1403 may be configured to implement functions and operations of the foregoing transmitting module 136.

The memory 1404 is connected to the processor 1401 through the bus 1405. The memory 1404 may be configured to store at least one instruction, and the processor 1401 is configured to execute the at least one instruction to implement operations in the foregoing method embodiments.

In addition, the memory 1404 may be implemented by using any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

In some embodiments, the receiver 1402 performs signal/data reception independently, or the processor 1401 controls the receiver 1402 to perform signal/data reception, or the processor 1401 requests the receiver 1402 to perform signal/data reception, or the processor 1401 cooperates with the receiver 1402 to perform signal/data reception.

In some embodiments, the transmitter 1403 performs signal/data transmission independently, or the processor 1401 controls the transmitter 1403 to perform signal/data transmission, or the processor 1401 requests the transmitter 1403 to perform signal/data transmission, or the processor 1401 cooperates with the transmitter 1403 to perform signal/data transmission.

In some embodiments of this application, a computer-readable storage medium is further provided. The computer-readable storage medium has at least one program stored thereon, and the at least one program is loaded and executed by a processor. The computer-readable storage medium implements the domain name query method provided in the foregoing method embodiments.

In some embodiments of this application, a chip is further provided. The chip includes a programmable logic circuit and/or program instructions. When running on a communication device, the chip is configured to implement the domain name query method provided in the foregoing method embodiments.

In some embodiments of this application, a computer program product is further provided. When the computer program product runs on a processor of a computer device, the computer device is enabled to implement the foregoing domain name query method.

In some embodiments of this application, a computer program is further provided. The computer program includes computer instructions, and a processor of the computer device executes the computer instructions to enable the computer device to perform the foregoing domain name query method.

A person skilled in the art may be aware that in the foregoing one or more examples, functions described in embodiments of this application may be implemented by using hardware, software, firmware, or any combination thereof. When implemented by using software, the functions may be stored in a computer-readable medium or transmitted as one or more instructions or code in a computer-readable medium. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely embodiments of this application, but are not intended to limit this application. Any modification, equivalent replacement, or improvement made within the spirit and principle of this application shall fall within the protection scope of this application.

What is claimed is:

1. A domain name query method, performed by a computer device, the method comprising:
receiving a domain name system (DNS) query request from a terminal device, the DNS query request comprising a domain name;
determining, based on cached data of a user plane function (UPF), an Internet protocol (IP) address corresponding to the domain name; and
transmitting a DNS response to the terminal device, the DNS response comprising the IP address corresponding to the domain name.

2. The method according to claim 1, the determining, based on cached data of a UPF, an Internet protocol (IP) address corresponding to the domain name comprises:
generating, in a case that the cached data of the UPF comprises the IP address corresponding to the domain name, the DNS response based on the IP address corresponding to the domain name.

3. The method according to claim 1, the determining, based on cached data of a UPF, an Internet protocol (IP) address corresponding to the domain name comprises:
transmitting the DNS query request to a DNS server in a case that the cached data of the UPF does not comprise the IP address corresponding to the domain name; and
receiving the DNS response from the DNS server,
the DNS server being located in a data network, the UPF being located in a core network, and the data network being connected to the core network.

4. The method according to claim 3, further comprising:
storing, in the cached data of the UPF, the IP address corresponding to the domain name in the DNS response.

5. The method according to claim 3, wherein the receiving the DNS response from the DNS server comprises:
receiving a data packet from the DNS server, a destination address of the data packet being an address of the terminal device; and
extracting the DNS response from the data packet; and
the method further comprises:
resolving, from the DNS response, the IP address corresponding to the domain name.

6. The method according to claim 1, wherein the receiving a DNS query request from a terminal device comprises:
receiving an uplink data packet transmitted from the terminal device, a destination address of the uplink data packet being an address of the DNS server; and
extracting the DNS query request from the uplink data packet; and
the method further comprises:
resolving the domain name from the DNS query request,
the DNS server being located in the data network, the UPF being located in the core network, and the data network being connected to the core network.

7. The method according to claim 1, wherein the cached data of the UPF is from the DNS server, and the DNS server is located in the data network.

8. The method according to claim 1, wherein the DNS query request comprises at least one of the following:
a user datagram protocol (UDP) based DNS query request;
a transmission control protocol (TCP) based DNS query request; or
a hypertext transfer protocol (HTTP) based DNS query request.

9. A computer device, comprising: a processor and a memory, the memory having a computer program stored therein, the computer program being loaded and executed by the processor, and the computer device implements a domain name query method, the method comprising:
receiving a domain name system (DNS) query request from a terminal device, the DNS query request comprising a domain name;
determining, based on cached data of a user plane function (UPF), an Internet protocol (IP) address corresponding to the domain name; and
transmitting a DNS response to the terminal device, the DNS response comprising the IP address corresponding to the domain name.

10. The computer device according to claim 9, wherein the determining, based on cached data of a UPF, an Internet protocol (IP) address corresponding to the domain name comprises:
generating, in a case that the cached data of the UPF comprises the IP address corresponding to the domain name, the DNS response based on the IP address corresponding to the domain name.

11. The computer device according to claim 9, wherein the determining, based on cached data of a UPF, an Internet protocol (IP) address corresponding to the domain name comprises:
transmitting the DNS query request to a DNS server in a case that the cached data of the UPF does not comprise the IP address corresponding to the domain name; and
receiving the DNS response from the DNS server,
the DNS server being located in a data network, the UPF being located in a core network, and the data network being connected to the core network.

12. The computer device according to claim 11, wherein the method further comprising:
storing, in the cached data of the UPF, the IP address corresponding to the domain name in the DNS response.

13. The computer device according to claim 11, wherein the receiving the DNS response from the DNS server comprises:
receiving a data packet from the DNS server, a destination address of the data packet being an address of the terminal device; and
extracting the DNS response from the data packet; and
the method further comprises:
resolving, from the DNS response, the IP address corresponding to the domain name.

14. The computer device according to claim 9, wherein the receiving a DNS query request from a terminal device comprises:
receiving an uplink data packet transmitted from the terminal device, a destination address of the uplink data packet being an address of the DNS server; and
extracting the DNS query request from the uplink data packet; and
the method further comprises:
resolving the domain name from the DNS query request,
the DNS server being located in the data network, the UPF being located in the core network, and the data network being connected to the core network.

15. The computer device according to claim 9, wherein the cached data of the UPF is from the DNS server, and the DNS server is located in the data network.

16. The computer device according to claim 9, wherein the DNS query request comprises at least one of the following:
a user datagram protocol (UDP) based DNS query request;
a transmission control protocol (TCP) based DNS query request; or
a hypertext transfer protocol (HTTP) based DNS query request.

17. A non-transitory computer-readable storage medium, having a computer program stored thereon, the computer program being loaded and executed by a processor, and the computer-readable storage medium implementing a domain name query method, the method comprising:
receiving a domain name system (DNS) query request from a terminal device, the DNS query request comprising a domain name;
determining, based on cached data of a user plane function (UPF), an Internet protocol (IP) address corresponding to the domain name; and
transmitting a DNS response to the terminal device, the DNS response comprising the IP address corresponding to the domain name.

18. The computer-readable storage medium according to claim 17, the determining, based on cached data of a UPF, an Internet protocol (IP) address corresponding to the domain name comprises:
generating, in a case that the cached data of the UPF comprises the IP address corresponding to the domain name, the DNS response based on the IP address corresponding to the domain name.

19. The computer-readable storage medium according to claim 17, the determining, based on cached data of a UPF, an Internet protocol (IP) address corresponding to the domain name comprises:
transmitting the DNS query request to a DNS server in a case that the cached data of the UPF does not comprise the IP address corresponding to the domain name; and
receiving the DNS response from the DNS server,
the DNS server being located in a data network, the UPF being located in a core network, and the data network being connected to the core network.

20. The computer-readable storage medium according to claim 19, further comprising:
storing, in the cached data of the UPF, the IP address corresponding to the domain name in the DNS response.
